(19) United States
(12) Patent Application Publication
(10) Pub. No.: US 2009/0183258 A1
(43) Pub. Date: Jul. 16, 2009

(54) PIRATE USER DETECTING APPARATUS, COLLUSION-SECURE CODE GENERATING APPARATUS, AND COLLUSION-SECURE CODE GENERATING PROGRAM

(75) Inventors: Taichi ISOGAI, Tokyo (JP); Hirofumi MURATANI, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 12/346,137

(22) Filed: Dec. 30, 2008

(30) Foreign Application Priority Data
Jan. 9, 2008 (JP) 2008-002052

(51) Int. Cl. G06F 12/14; G06F 17/00

(52) U.S. Cl. 726/22; 706/54

(57) ABSTRACT

A pirate user detecting apparatus includes an extracting unit that extracts, from a digital content, a part or all of a collusion-secure code embedded in correspondence with each of users and that makes it possible to trace pirate users who have made a collusion attack; a calculating unit that calculates a correlation value for each of bits between the part or all of the extracted collusion-secure code and a code assigned to a corresponding one of the users, and calculates a total score of the correlation values for each of the users; a first specifying unit that specifies a threshold value for judging whether each of the users is a pirate user, based on a code length of the extracted collusion-secure code; and a judging unit that judges whether each of the users is a pirate user using the specified threshold value and the calculated total score of each user.

### CROSS-REFERENCE TO RELATED APPLICATIONS

This application is based upon and claims the benefit of priority from the prior Japanese Patent Application No. 2008-002052, filed on Jan. 9, 2008; the entire contents of which are incorporated herein by reference.

### BACKGROUND OF THE INVENTION

1. Field of the Invention

The present invention relates to a pirate user detecting apparatus that detects pirate users based on a collusion-secure code that is embedded in a content and is used for countering counterfeit digital watermarks and to a collusion-secure code generating apparatus and a collusion-secure code generating computer program for generating collusion-secure codes.

2. Description of the Related Art

In recent years, digital contents are dealt with in more and more situations, due to the development in computer and network technologies. One of the characteristics of digital contents is that people are able to create a content that is exactly the same as an original content at a very low cost. Thus, from the standpoint of protecting the copyrights of digital contents, it is essential to take countermeasures against illegal copying of digital contents. Examples of the countermeasures that are taken to prevent illegal copying include digital watermark techniques and fingerprinting techniques. Digital watermark techniques are realized by embedding information into digital contents. Fingerprinting techniques are realized by embedding a user ID into a digital content by using an digital watermark technique and, when a copy of the content is illegally circulated, tracing a user who has illegally copied the digital content (hereinafter, an “pirate user”) based on the embedded ID.

However, there is a possibility that fingerprinting techniques may be subject to a collusion attack, which is realized by collecting a plurality of digital contents together in which mutually different identifiers (IDs) are embedded respectively and rewriting the differences among these IDs so as to make it impossible to identify the users from the IDs. Such a collusion attack makes it impossible to trace pirate users. Thus, it is essential to take countermeasures against collusion attacks. Examples of countermeasures against collusion attacks include embedding a collusion-secure code into a digital content, instead of embedding an ID.

An example of collusion-secure codes is the c-secure code (with e error). With this code, if the number of colluders who have made a collusion attack is equal to or smaller than c, it is possible to keep the probability of being unable to trace (i.e., accuse) any of the colluders (i.e., the pirate users) or the probability (i.e., the error probability) of erroneously tracing users who have not made a collusion attack equal to or lower than e. Specific examples in which such a code is structured include Tardos code and Nuida Hagiwara Watanabe Imai (NHWI) code. Tardos code is described in, for example, “Optimal probabilistic fingerprint codes”, the Annual ACM Symposium on Theory of Computing (STOC), pp. 116-125, 2003. NHWI code is described in, for example, “Optimal probabilistic fingerprint codes using optimal finite random variables related to numerical quadrature”, CR/0610036, arxiv.org. According to each of the techniques described in these documents, the code is structured by using a predetermined rule and calculating, for each of the bits, the distribution of the occurrence probability of the code symbol's being the value “1”. According to each of the techniques, it is judged whether each of the users is a pirate user by using a score calculated based on a correlation between a code after a collusion attack has been made and the user's code. The algorithm is structured so that, when a user's score is judged to exceed a threshold value Z, the user will be accused of being a pirate user. In other words, when the score of a user “j” is expressed as Sⱼ, the user “j” will be accused of being a pirate user if “Sⱼ=Z” is satisfied.

The code length of Tardos code is defined as “100c²k”, whereas the threshold value used for judging whether a user is a pirate user is defined as “20ck”. In these expressions, “c” denotes the number of colluders; “n” denotes the number of users; “e” denotes the error probability; and “k” is expressed by Expression 1.

┌ln(n/ε)┐ (1)

Also for NHWI code, a code length and a threshold value are defined according to specified conditions such as the number of colluders and the number of users. Both of the methods described above are based on an assumption that a code is generated according to the conditions specified in advance, so that the generated code is embedded into each content, the code is extracted from a content on which a collusion attack has been made, a score Sⱼ is calculated for each of the users based on the entirety of the code on which the collusion attack has been made, and pirate users are identified by using a specified threshold value.

To trace the pirate users, however, it is necessary to calculate the scores while using all the bits as the targets. Thus, to judge whether each of the users is a pirate user, a huge amount of calculations are required. In addition, another problem is that there is a situation in which it is not possible to judge whether each of the users is a pirate user under a specified safety condition, unless all the bits have been extracted from a content.

### SUMMARY OF THE INVENTION

According to one aspect of the present invention, a pirate user detecting apparatus includes an extracting unit that extracts, from a digital content, a part or all of a collusion-secure code that is embedded in correspondence with each of users and that makes it possible to trace pirate users who have made a collusion attack; a calculating unit that calculates a correlation value for each of bits between the part or all of the extracted collusion-secure code and a code assigned to a corresponding one of the users, and calculates a total score of the correlation values for each of the users; a first specifying unit that specifies a threshold value used for judging whether each of the users is a pirate user, based on a code length of the part or all of the extracted collusion-secure code; and a judging unit that judges whether each of the users is a pirate user by using the specified threshold value and the calculated total score of each user.

According to another aspect of the present invention, a collusion-secure code generating apparatus that generates a collusion-secure code to be embedded into a digital content in correspondence with each of users so as to make it possible to trace pirate users who have made a collusion attack, the apparatus includes a specifying unit that specifies a code length based on a number indicating how many pirate users are estimated, a number indicating how many users there are, and an error probability indicating a probability of erroneously judging any of the users as pirate users; and a generating unit that generates the collusion-secure code having the specified code length, wherein when a pirate user detecting apparatus operable to detect pirate users by using the collusion-secure code is able to perform a judging process of judging whether each of the users is a pirate user a plurality of times per user, the specifying unit specifies the code length according to a maximum number-of-times value t (t: an integer that is equal to or larger than 2) indicating a maximum number of times the pirate user detecting apparatus is able to perform the judging process.

According to still another aspect of the present invention, a computer program product having a computer readable medium including programmed instructions, wherein the instructions, when executed by a computer, cause the computer to perform: extracting, from a digital content, a part or all of a collusion-secure code that is embedded in correspondence with each of users and that makes it possible to trace pirate users who have made a collusion attack; calculating correlation value for each of bits between the part or all of the extracted collusion-secure code and a code assigned to a corresponding one of the users, and calculating a total score of the correlation values for each of the users; specifying a threshold value used for judging whether each of the users is a pirate user, based on a code length of the part or all of the extracted collusion-secure code; and judging whether each of the users is a pirate user by using the specified threshold value and the calculated total score of each user.

According to still another aspect of the present invention, a computer program product having a computer readable medium including programmed instructions, when executed by a computer included in a collusion-secure code generating apparatus that generates a collusion-secure code to be embedded into a digital content in correspondence with each of users so as to make it possible to trace pirate users who have made a collusion attack, wherein the instructions cause the computer to perform: specifying a code length based on a number indicating how many pirate users are estimated, a number indicating how many users there are, and an error probability indicating a probability of erroneously judging any of the users as pirate users; and generating the collusion-secure code having the specified code length, wherein when a pirate user detecting apparatus operable to detect pirate users by using the collusion-secure code is able to perform a judging process of judging whether each of the users is a pirate user a plurality of times per user, the code length is specified according to a maximum number-of-times value t (t: an integer that is equal to or larger than 2) indicating a maximum number of times the pirate user detecting apparatus is able to perform the judging process.

### BRIEF DESCRIPTION OF THE DRAWINGS

FIG. 1 is a functional diagram of a pirate user detecting apparatus according to a first embodiment of the present invention;

FIG. 2 is a flowchart of a procedure in a process performed by a pirate user detecting apparatus 100 according to the first embodiment;

FIG. 3 is a diagram in which distributions of the number of innocent users and the number of pirate users based on their scores with Tardos code according to the first embodiment are shown in a simplified manner;

FIG. 4 is a diagram in which distributions of the number of innocent users and the number of pirate users that are obtained by using a code length that is shorter than the code length used in the example in FIG. 3 are shown in a simplified manner;

FIG. 5 is a diagram in which distributions of the scores of pirate users and innocent users for each of different code lengths are shown in correspondence with a certain number of colluders, the number being relatively large;

FIG. 6 is a diagram in which distributions of the scores of pirate users and innocent users for each of different code lengths are shown in correspondence with a number of colluders, the number being smaller than the number in the example shown in FIG. 5;

FIG. 7 is a functional diagram of a pirate user detecting apparatus according to a second embodiment of the present invention;

FIG. 8 is a diagram for illustrating that the scores calculated for users vary depending on the code length, i.e., depending on which judging process cycle the users are judged in;

FIG. 9 is a flowchart of a procedure in a process performed by a pirate user detecting apparatus 200 according to the second embodiment;

FIG. 10 is an exemplary functional diagram of a collusion-secure code generating apparatus 500 according to the second embodiment; and

FIG. 11 is a flowchart of a procedure in a collusion-secure code generating process performed by the collusion-secure code generating apparatus 500 according to the second embodiment.

### DETAILED DESCRIPTION OF THE INVENTION

A pirate user detecting apparatus according to a first embodiment of the present invention includes a controlling device such as a Central Processing Unit (CPU) that exercises the overall control of the apparatus; storage devices such as a Read-Only Memory (ROM) and a Random Access Memory (RAM) that store therein various types of data and various types of computer programs (hereinafter, “programs”); external storage devices such as a Hard Disk Drive (HDD) and a Compact Disk (CD) drive device that store therein various types of data and various types of programs; and a bus that connects these constituent elements to one another. The pirate user detecting apparatus has a hardware configuration to which a commonly-used computer can be applied.

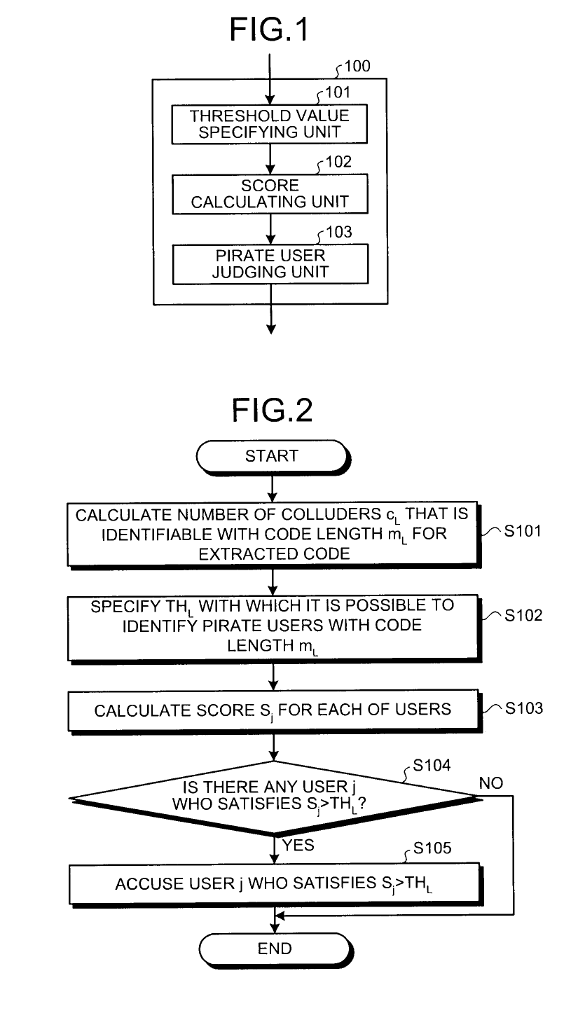

Next, various types of functions that are realized in the hardware configuration described above when the pirate user detecting apparatus executes the various types of programs stored in the storage devices and the external storage devices will be explained. FIG. 1 is a functional diagram of the pirate user detecting apparatus according to the first embodiment. A pirate user detecting apparatus 100 shown in FIG. 1 includes a code extracting unit (not shown), a threshold value specifying unit 101, a score calculating unit 102, and a pirate user judging unit 103.

The code extracting unit extracts all or a part of a collusion-secure code from a digital content that is a target of the extracting process. The threshold value specifying unit 101 specifies a threshold value to be used in a judging process of judging whether each of users is a pirate user, based on the code length of the collusion-secure code that has been extracted by the code extracting unit. The score calculating unit 102 calculates a correlation value for each of the bits between all or the part of the collusion-secure code that has been extracted by the code extracting unit and a code that has been assigned to each of the users. The score calculating unit 102 then calculates a total of the correlation values of the bits for each of the users, as the user's score. To calculate the scores, it is acceptable to use the method descried in, for example, “Optimal probabilistic fingerprint codes”, STOC, pp. 116-125, 2003, which is related to Tardos code. The pirate user judging unit 103 judges whether each of the users is a pirate user by using the user's score that has been calculated by the score calculating unit 102 and the threshold value specified by the threshold value specifying unit 101.

Next, a procedure in a process performed by the pirate user detecting apparatus 100 according to the first embodiment will be explained with reference to FIG. 2. In the first embodiment, an example in which it is possible to extract only a part of a collusion-secure code will be explained, the collusion-secure code having been embedded in a digital content that is a target of the extracting process. First, the code extracting unit included in the pirate user detecting apparatus 100 extracts a part of the collusion-secure code from the digital content that is a target of the extracting process. The code length of the extracted part of the collusion-secure code will be expressed as m_{L}. Subsequently, the threshold value specifying unit 101 specifies a threshold value TH_{L} to be used in the judging process of judging whether each of the users is a pirate user, according to the code length m_{L} of the code that has been extracted at step S101. When Tardos code is used, the threshold value may be specified in the following manner, for example: The threshold value specifying unit 101 calculates the number of colluders c_{L} that satisfies “m_{L}=100c_{L}²k” (step S101) and specifies the threshold value TH_{L} so that “TH_{L}=20c_{L}k” is satisfied (step S102). In other words, “TH_{L}=2v(m_{L}k))” is satisfied. The value of k can be expressed by Expression 1 above. These different types of constants are stored in advance in any of the storage devices and the external storage devices.

After that, the score calculating unit 102 calculates a correlation value for each of the bits between the code that has been extracted by the code extracting unit and a code that has been assigned to each of the users. The score calculating unit 102 further calculates a total of the correlation values of the bits for each of the users, as the user's score (step S103). Subsequently, the pirate user judging unit 103 judges whether each user j is a pirate user, by using the score Sj of the user j that has been calculated by the score calculating unit 102 and the threshold value TH_{L} that has been specified by the threshold value specifying unit 101. More specifically, in the case where the score of a user is higher than the threshold value TH_{L}, the pirate user judging unit 103 judges that the user is a pirate user. On the contrary, in the case where the score of a user is equal to or lower than the threshold value TH_{L}, the pirate user judging unit 103 judges that the user is innocent (hereinafter, an “innocent user”).

It is, however, difficult to directly evaluate scores of pirate users. The attack algorithm is unknown, and there may be a deviation in the distribution of the scores depending on the attack algorithm being used. Thus, Tardos et al. has evaluated the probability of being able to accuse pirate users based on whether the average score of the pirate users exceeds a threshold value TH. The reason for this is that, when the average score is used, it is possible to make an evaluation regardless of what attack algorithm is being used and that if the average score of the pirate users exceeds the threshold value TH, it means that the score of at least one of the pirate users should exceed the threshold value TH and accusation becomes possible.

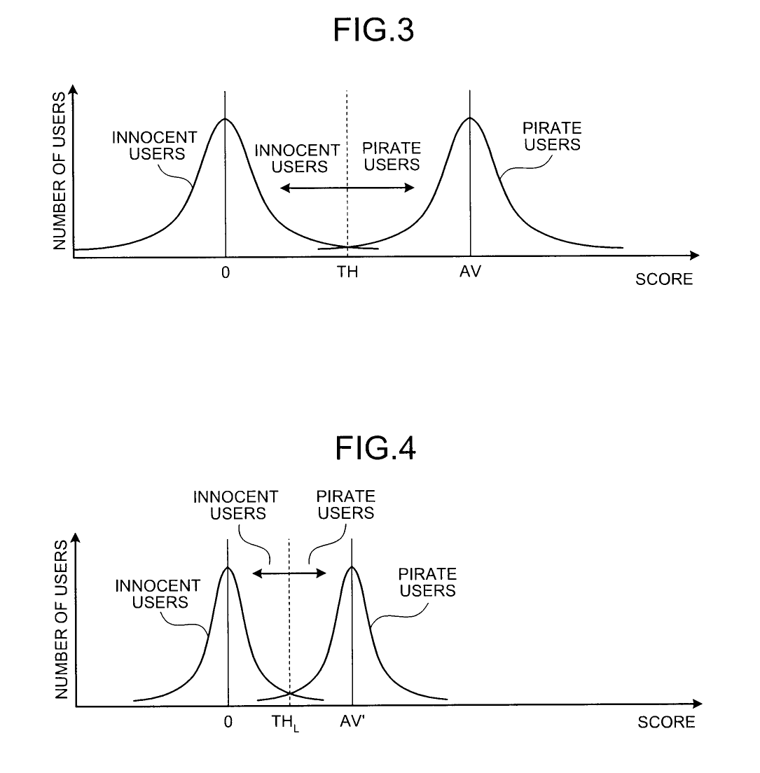

Next, the judging process that is performed by using the threshold value TH_{L} will be explained. FIG. 3 is a diagram in which frequency distributions (or may be probability distributions) of innocent users and pirate users based on their scores with Tardos code are shown in a simplified manner. As shown in FIG. 3, the average of the scores of the innocent users is “0” point. The distribution shows that the innocent users are concentrated near the “0” point and that the farther the distance from the “0” point is, the smaller the number of innocent users becomes. On the other hand, the average AV of the scores of the pirate users is higher than “0” point. The distribution shows that the average score of the pirate users is concentrated near the average point AV and that the farther the distance from AV is, the smaller the number of pirate users becomes. Based on these distributions, if the score of a user is equal to or lower than the threshold value TH, which is appropriately specified, it is possible to judge that the user is an innocent user. On the contrary, if the score of a user is higher than the threshold value TH, it is possible to judge that the user is a pirate user.

Each of the frequency distributions of the innocent users and the pirate users varies depending on the code length. The shorter the code length is, the smaller the dispersion of each of the distributions becomes. FIG. 4 is a diagram in which frequency distributions of innocent users and pirate users that are obtained by using a code length that is shorter than the code length used in the example in FIG. 3 are shown in a simplified manner. As shown in FIG. 4, in this situation, it is necessary to specify a threshold value (i.e., TH_{L}) that is smaller than the threshold value TH used for the distributions shown in FIG. 3. Accordingly, at step S102 described above, the threshold value specifying unit 101 specifies the threshold value TH_{L} to be used in the judging process of judging whether each of the users is a pirate user, according to the code length m_{L}. As explained here, because the pirate user judging unit 103 performs the judging process of judging whether each of the users is a pirate user by using the threshold value TH_{L} that has been specified according to the code length m_{L}, the pirate user judging unit 103 is able to perform the judging process in an appropriate manner.

Returning to the description of FIG. 2, after the process at step S104 has been performed, the pirate user judging unit 103 accuses those users who have been judged to be pirate users of being colluders (step S105). In the case where the pirate user judging unit 103 has judged none of the users to be pirate users, in other words, in the case where the score of each of all the users is equal to or lower than the threshold value TH_{L} (step S104: No), it is assumed that it is not possible to trace the pirate users by using the code length m_{L} of the extracted code and the process is ended.

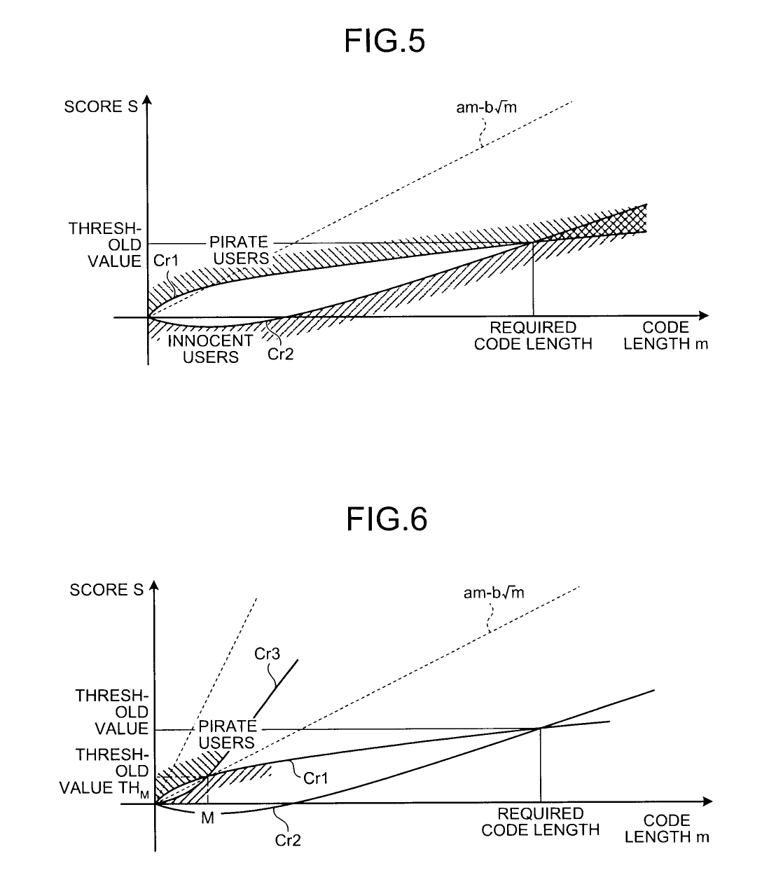

Next, the code length used according to the first embodiment will be explained. FIG. 5 is a diagram in which distributions of the scores of pirate users and innocent users for each of different code lengths are shown in correspondence with a certain number of colluders, the number being relatively large. In FIG. 5, each of the curved lines Cr1 and Cr2 shows a threshold value used for judging whether each of the users is a pirate user. When the value of a user's score is above the curved line Cr1, the user is judged to be a pirate user because it is extremely rare (i.e., the probability is equal to or lower than a presumed error probability) for an innocent user to have such a score. On the contrary, when the value of a user's score is on or below the curved line Cr1, the user is judged to be an innocent user. When the value of a user's score is on or below the curved line Cr2, the user is judged to be an innocent user because it is also extremely rare (i.e., the probability is equal to or lower than the presumed error probability) for all the pirate users to have such a score. On the contrary, when the value of a user's score is above the curved line Cr2, the user is judged to be a pirate user. In these distributions, the point at which the curved lines Cr1 and Cr2 intersect each other indicates a code length (hereinafter, the “required code length”) with which it is possible to appropriately judge pirate users and innocent users and a corresponding threshold value.

FIG. 6 is a diagram in which distributions of the scores of pirate users and innocent users for each of different code lengths are shown in correspondence with a number of colluders, the number being smaller than the number in the example shown in FIG. 5. In this situation, the slope of the curved line Cr3 indicating the threshold value to be used for judging whether each of the users is a pirate user is steeper than the slope of the curved line Cr2. Thus, the intersection of the curved line Cr1 and the curved line Cr3 is closer to the point of origin than the intersection of the curved line Cr1 and the curved line Cr2 is. Accordingly, the required code length M corresponding to the smaller number of colluders is shorter than the required code length corresponding to the larger number of colluders. In other words, in the case where the number of colluders is smaller, it is possible to appropriately judge whether each of the users is a pirate user by using a shorter code length (i.e., the required code length is shorter) than in the case where the number of colluders is larger.

With the arrangement above, even if it is not possible to extract the entirety of a code from a digital content, it is possible to appropriately judge whether each of the users is a pirate user by specifying the threshold value based on the estimated number of colluders according to the code length of the extracted code. Thus, even in such a situation, it is possible to efficiently trace pirate users.

Next, a second embodiment of the pirate user detecting apparatus according to the present invention will be explained. Parts of the second embodiment that are the same as the first embodiment will be explained by using the same reference characters or will be omitted from the explanation.

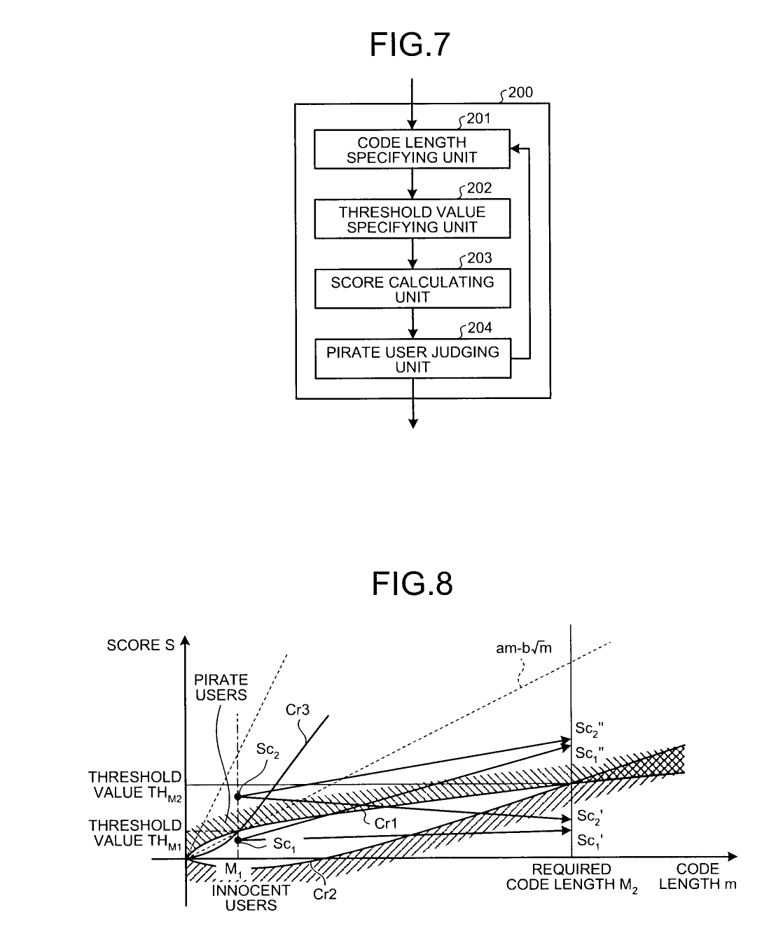

According to the second embodiment, the pirate user detecting apparatus traces pirate users by using a code length that is shorter than an originally estimated code length. FIG. 7 is a functional diagram of the pirate user detecting apparatus according to the second embodiment. The parts that are different from the first embodiment will be explained. In this functional configuration, a pirate user detecting apparatus 200 according to the second embodiment includes a code extracting unit (not shown), a code length specifying unit 201, a threshold value specifying unit 202, a score calculating unit 203, and a pirate user judging unit 204. The code length specifying unit 201 specifies a code length to be used in the judging process of judging whether each of the users is a pirate user according to how many times the judging process has been performed (hereinafter, the “judging process number-of-times value”, so that all or a part of the code that has been extracted by the code extracting unit is used. The threshold value specifying unit 202 specifies a threshold value to be used in the judging process of judging whether each of the users is a pirate user, based on the code length that has been specified by the code length specifying unit 201. The score calculating unit 203 calculates a correlation value for each of the bits between a code that is all or a part of the code having been extracted by the code extracting unit and that has the code length having been specified by the code length specifying unit 201 and a code that has been assigned to each of the users. The score calculating unit 203 then calculates a total of the correlation values of the bits for each of the users, as the user's score. The pirate user judging unit 204 judges whether each of the users is a pirate user, by using the user's score that has been calculated by the score calculating unit 203 and the threshold value that has been specified by the threshold value specifying unit 202.

In the configuration described above, the pirate user detecting apparatus 200 performs the judging process of judging whether each of the users is a pirate user at most “t” times per user (t: a positive integer that is equal to or larger than 1). The value expressed with “t” will be referred to as the maximum number-of-times value. The value of the maximum number-of-times value “t” is specified in advance and is stored in any of the storage devices and the external storage devices. In the first judging process cycle, the pirate user detecting apparatus 200 specifies a code length corresponding to the first judging process cycle, specifies a threshold value based on the code length, and performs the judging process of judging whether each of the users is a pirate user by using the threshold value. In the case where none of the users have been judged to be a pirate user, if the judging process number-of-times value has not reached “t” yet, during the next judging process cycle, the pirate user detecting apparatus 200 specifies a code length corresponding to the judging process number-of-times value, specifies a threshold value based on the code length, and performs the judging process of judging whether each of the users is a pirate user by using the threshold value. In the case where none of the users have been judged to be a pirate user again in this judging process cycle, the same judging process described above is repeated in the next judging process cycle until the judging process number-of-times value reaches “t”.

In this situation, the estimated number of colluders is in correspondence with the judging process number-of-times value. The code length is specified so as to specify a threshold value that makes it possible to trace pirate users equaling the number of colluders that corresponds to the judging process number-of-times value. For example, let us assume that the estimated number of colluders “2” is in correspondence with the judging process number-of-times value “1”; the estimated number of colluders “4” is in correspondence with the judging process number-of-times value “2”; the estimated number of colluders “8” is in correspondence with the judging process number-of-times value “3”; and the estimated number of colluders “10” is in correspondence with the judging process number-of-times value “4”. On this assumption, the maximum number-of-times value is specified so that “t=4” is satisfied, while the number of colluders cᵤ corresponding to the judging process number-of-times value u is specified so that “c₁=2”, “c₂=4”, “c₃=8”, and “c₄=10” are satisfied. The number of colluders corresponding to the maximum number-of-times value t (hereinafter, the “maximum number of colluders”) will be expressed as cₘₐₓ. In other words, in the present example, the estimated number of colluders is specified in such a manner that the larger the judging process number-of-times value is, the larger the estimated number of colluders is.

In the case where none of the users have been judged to be a pirate user, the pirate user detecting apparatus 200 extends the code length by using the number of colluders corresponding to the judging process number-of-times value and specifies the threshold value to be used in the next judging process cycle based on the extended code length.

The reason why the code length is specified according to the judging process number-of-times value can be explained as follows: As explained above, in the case where the judging process is performed a plurality of times (i.e., a plurality of cycles) per user, there is a possibility that an innocent user may be judged to be a pirate user depending on the judging process cycle in which he/she is judged. FIG. 8 is a diagram for illustrating that the scores calculated for users vary depending on the code length, i.e., depending on which judging process cycle the users are judged in. For example, in the case where a score Sc₁ has been calculated for a user in a judging process cycle in which the required code length is M₁, another score Sc₁″ may be calculated for the same user in another judging process cycle in which the required code length is M₂. In this situation, in the former judging process cycle, because the score Sc₁ is equal to or lower than the threshold value TH_{M1} corresponding to the required code length M₁, the user is judged to be innocent. On the other hand, in the latter judging process cycle, because the score Sc₁″ is higher than the threshold value TH_{M2} corresponding to the required code length M₂, the user is judged to be a pirate user. As another example, in the case where a score Sc₂ has been calculated for a user in a judging process cycle in which the required code length is M₁, another score Sc₂′ may be calculated for the same user in another judging process cycle in which the required code length is M₂. In this situation, in the former judging process cycle, because the score Sc₂ is higher than the threshold value TH_{M1} corresponding to the required code length M₁, the user is judged to be a pirate user. On the other hand, in the latter judging process cycle, because the score Sc₂′ is equal to or lower than the threshold value TH_{M2} corresponding to the required code length M₂, the user is judged to be innocent. In another situation in which a score Sc₁ has been calculated for a user in a judging process cycle in which the required code length is M₁, before another score Sc₁′ is calculated for the same user in another judging process cycle in which the required code length is M₂, or in yet another situation in which a score Sc₂ has been calculated for a user in a former judging process cycle before another score Sc₂″ is calculated for the same user in a latter judging process cycle, there is no problem because the judging results are the same for the former judging process cycle and the latter judging process cycle.

As explained above, in the case where the judging process is performed a plurality of times (i.e., a plurality of cycles), if one user is erroneously judged, the probability events increase by the number of times an erroneous judgment is made. Thus, the probability of making erroneous judgments will become higher. Accordingly, in the case where the judging process is performed a plurality of times (i.e., a plurality of cycles), there is a possibility that the probability of making erroneous judgments may exceed the error probability “e”, that is, the error probability “e” specified in correspondence with the case where the judging process is performed only once per user. Thus, the code length is specified according to the judging process number-of-times value.

On the other hand, to keep the probability of making erroneous judgments equal to or lower than the error probability “e”, a code length expressed by Expression 2 is sufficient even in a worst-case scenario, when the code length required for detecting as many colluders as “c” is expressed as m_{c} according to the technique in the related art.

m_{c}(1+┌ln(t)/ln(n/ε)┐) (2)

Thus, in the example in which Tardos code is used, the maximum number of colluders “cₘₐₓ” indicating the largest possible number of colluders is estimated, and a code that has the length expressed by Expression 3 (hereinafter, the “maximum code length”) will be necessary in correspondence with the maximum number-of-times value “t”.

100c_{MAX}²┌ln(t·n/ε)┐ (3)

Consequently, in advance, it is necessary to embed, into the digital content that is the target of the extracting process, a collusion-secure code having the maximum code length that is required in correspondence with the maximum number of colluders “cₘₐₓ”. In the following explanation, it is assumed that a collusion-secure code having the maximum code length is embedded in advance in the digital content that is the target of the extracting process. A collusion-secure code generating apparatus that generates such a collusion-secure code will be explained later.

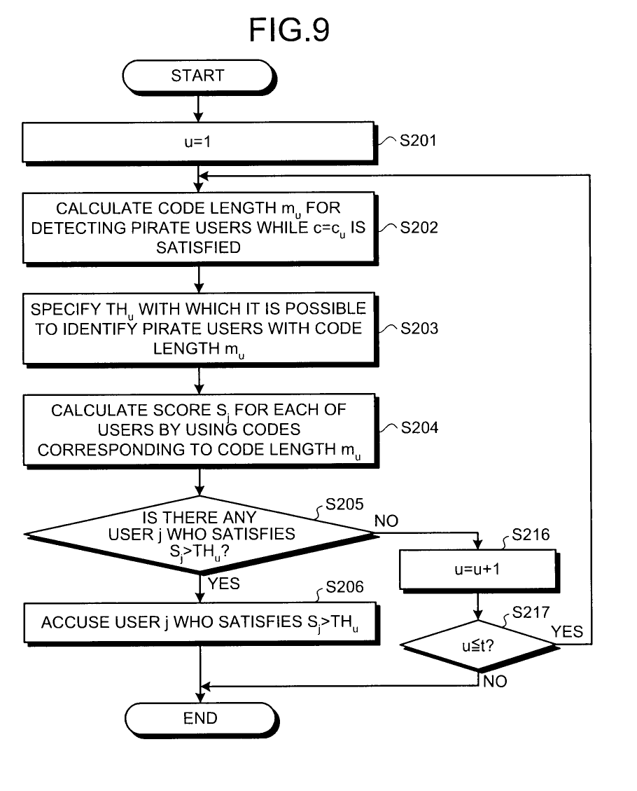

Next, a procedure in a process performed by the pirate user detecting apparatus 200 according to the second embodiment will be explained, with reference to FIG. 9. First, the judging process number-of-times value u is set to “1” (step S201). The code length specifying unit 201 specifies a code length mᵤ to be used for detecting pirate users according to the judging process number-of-times u, the code length mᵤ indicating the length for the code that has been extracted by the code extracting unit (step S202). In this situation, to specify the code length mᵤ according to the judging process number-of-times u means to specify the code length according to the number of colluders cᵤ that is estimated in correspondence with the judging process number-of-times value u. In the case where Tardos code is used, for example, if the number of colluders that the operator of the apparatus wishes to be able to trace in the first judging process cycle (i.e., the judging process number-of-times value u is “1”) is expressed as “c₁”, the code length mᵤ is specified as a value expressed by Expression 4 below. Other situations in which the judging process number-of-times value u is “2” or larger will be explained later.

100c₁²┌ln(n/ε)┐ (4)

Next, the threshold value specifying unit 202 specifies a threshold value THᵤ to be used in the judging process of judging whether each of the users is a pirate user, by using the code length mᵤ that has been specified at step S202 (step S203). The score calculating unit 203 calculates a correlation value for each of the bits between a code that is all or a part of the code having been extracted by the code extracting unit and that has the code length mᵤ having been specified by the code length specifying unit 201 and the code that has been assigned to each of the users and has the code length mᵤ. The score calculating unit 203 further calculates a total of the correlation values of the bits for each of the users, as the user's score. The pirate user judging unit 204 judges whether each user j is a pirate user, by using the score Sj of the user j that has been calculated by the score calculating unit 203 and the threshold value THᵤ that has been specified by the threshold value specifying unit 202. After that, the pirate user judging unit 204 accuses the users that have been judged to be pirate users (step S206). In the case where the pirate user judging unit 204 has judged none of the users to be pirate users, in other words, in the case where the score Sⱼ of each of all the users j is equal to or lower than the threshold value THᵤ (step S205: No), the judging process number-of-times value u is incremented by “1” (step S216), and if the judging process number-of-times value u is still equal to or smaller than “t” (step S217: Yes), the process returns to step S202.

In the case where the judging process number-of-times value u is “2”, at step S202 the code length specifying unit 201 specifies the code length m₂ so as to be a value expressed by Expression 5 below, while assuming that the number of colluders c is “c₂” that is in correspondence with the judging process number-of-times value u.

100c₂²┌ln(2n/ε)┐ (5)

Subsequently, at step S203, the threshold value specifying unit 202 specifies a threshold value THᵤ to be used in the judging process of judging whether each of the users is a pirate user, by using the code length mᵤ that has been specified at step S202 that immediately preceded this step. After that, the same process is repeatedly performed. In the case where the judging process number-of-times value u is “r” (where 2<r<t), at step S202 the code length specifying unit 201 specifies the code length so as to be a value expressed by Expression 6 below, while assuming that the number of colluders c is “cᵣ” that is in correspondence with the judging process number-of-times value u.

100cᵣ²┌ln(r·n/ε)┐ (6)

In the case where the judging process number-of-times value u has reached “t”, at step S202 the code length specifying unit 201 specifies the code length so as to be a value expressed by Expression 7 below, while assuming that the number of colluders c is “cₘₐₓ” that is the maximum number of colluders corresponding to the maximum number-of-times value “t”.

100c_{MAX}²┌ln(t·n/ε)┐ (7)

In the manner described above, the code length specifying unit 201 specifies the code length mᵤ by using the judging process number-of-times value u and the number of colluders that is estimated in correspondence with the judging process number-of-times value u. Further, the threshold value specifying unit 202 specifies the threshold value THᵤ according to the specified code length mᵤ, so that the pirate user judging unit 204 judges whether each of the users is a pirate user by using the specified threshold value THᵤ. After that, at step S217, in the case where the judging process number-of-times value u has become larger than “t” (step S217: No), the process is ended because it is no longer possible to trace pirate users by using the extracted code.

As explained above, according to the second embodiment, in the first judging process cycle, the judging process of judging whether each of the users is a pirate user is performed by using a code length that is shorter than the maximum code length, based on the estimated number of colluders that is smaller than the maximum number of colluders. In the case where none of the users have been judged to be a pirate user in the first judging process cycle, the code length is re-specified so that the judging process of judging whether each of the users is a pirate user is performed again. In this situation, the number of colluders is estimated in such a manner that the larger the judging process number-of-times value is, the larger the estimated number of colluders becomes. As a result, the judging process of judging whether each of the users is a pirate user is performed again, by using the code length that becomes longer as the judging process number-of-times value increases. In this manner, when the number of colluders is estimated to be smaller than the maximum number of colluders that is presumed at the time when the code is generated, only a part of the collusion-secure code is used, instead of the entirety of the collusion-secure code. Thus, it is possible to reduce the amount of calculations required to calculate the scores and to determine the pirate users in the manner described above. Consequently, it is possible to trace pirate users more efficiently.

Also, as explained above, by specifying the code length that makes it possible to detect the number of colluders that is estimated in correspondence with the judging process number-of-times value, while keeping the probability of making erroneous judgments lower than the presumed value, it is possible to satisfy the specified safety conditions.

Next, a collusion-secure code generating apparatus that generates a collusion-secure code will be explained in correspondence with the case where the pirate user detecting apparatus 200 performs the judging process of judging whether each of the users is a pirate user at most “t” times per user (i.e., the maximum number-of-times value explained above). The collusion-secure code generating apparatus includes: a controlling device such as a Central Processing Unit (CPU) that exercises the overall control of the apparatus; storage devices such as a Read-Only Memory (ROM) and a Random Access Memory (RAM) that store therein various types of data and various types of programs; external storage devices such as a Hard Disk Drive (HDD) and a Compact Disk (CD) drive device that store therein various types of data and various types of programs; and a bus that connects these constituent elements to one another. The collusion-secure code generating apparatus has a hardware configuration to which a commonly-used computer can be applied.

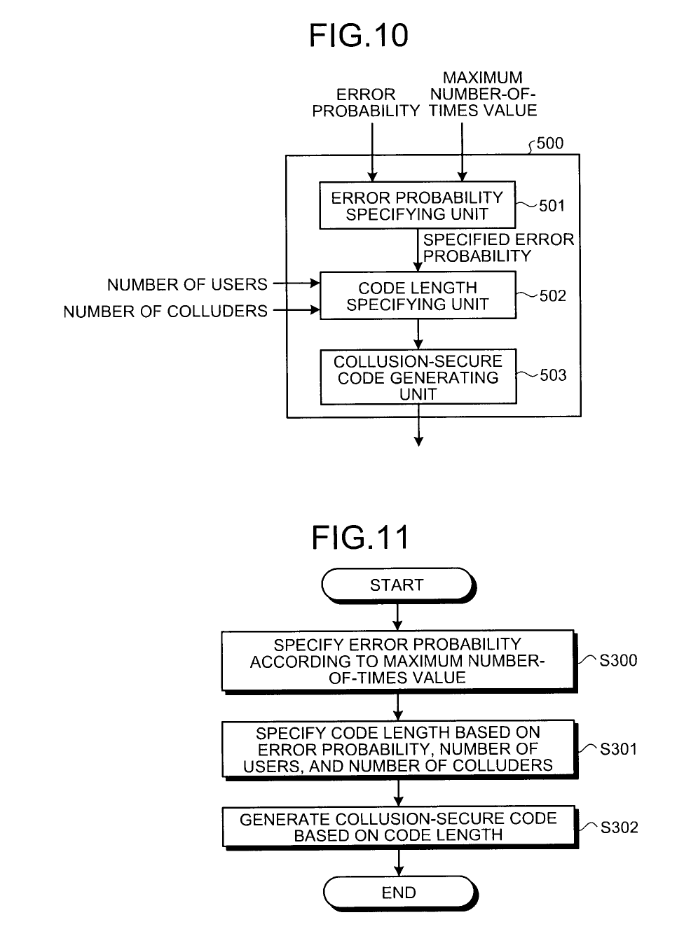

Next, various types of functions that are realized in the hardware configuration described above when the collusion-secure code generating apparatus executes the various types of programs stored in the storage devices and the external storage devices will be explained. FIG. 10 is an exemplary functional diagram of a collusion-secure code generating apparatus 500. The collusion-secure code generating apparatus 500 shown in FIG. 10 includes an error probability specifying unit 501, a code length specifying unit 502, and a collusion-secure code generating unit 503. As the error probability used for specifying a code length, the error probability specifying unit 501 specifies an error probability value so that the error probability is equal to or lower than “1/t” times the error probability used in the case where the maximum number-of-times value indicating the largest number of times the judging process is performed is 1. The code length specifying unit 502 specifies the code length, based on the error probability that has been specified by the error probability specifying unit 501, the estimated number of colluders (i.e., the number of pirate users), and the number of users. The collusion-secure code generating unit 503 generates a collusion-secure code having the code length that has been specified by the code length specifying unit 502.

There is no particular limitation to the maximum number-of-times value “t”, The maximum number-of-times value “t” is specified in advance and is stored in any of the storage devices and the external storage devices. It is also assumed that the number of users, the estimated number of colluders, and the error probability “e” that are used for generating the collusion-secure code are also stored in advance in any of the storage devices and the external storage devices.

Next, a procedure in a collusion-secure code generating process performed by the collusion-secure code generating apparatus 500 will be explained, with reference to FIG. 11. The error probability specifying unit 501 included in the collusion-secure code generating apparatus 500 reads the error probability “e” and the maximum number-of-times value “t” that are stored in any of the storage devices and the external storage devices and re-specifies the error probability so that the re-specified error probability value is equal to or lower than “1/t” times the read error probability (step S300). Subsequently, the code length specifying unit 502 reads the number of colluders and the number of users that are stored in any of the storage devices and the external storage devices and specifies a code length based on these read numbers and the error probability that has been specified at step S300 (step S301). The collusion-secure code generating unit 503 generates a collusion-secure code having the code length that has been specified at step S301 (step S302).

In a Tardos code structuring method, when the error probability is expressed as “e”, the probability of being unable to accuse any pirate user” is expressed as “e/n”, while the probability of “accusing innocent users of being pirate users” is expressed as “(n−1)e/n”, of which the probability of “accusing an innocent user of being a pirate user” is equal to or lower than “e/n”. When all of the above is taken into consideration, it would be sufficient if only the probability of “accusing an innocent user of being a pirate user” were multiplied by “1/t”. At step S300, however, an attempt is made to calculate the code length by multiplying, also, the probability of “being unable to accuse any pirate user” by “1/t”. Needless to say, it is apparent that it would be possible to shorten the code length if the code length were re-specified by multiplying only the probability of “accusing an innocent user of being a pirate user” by “1/t”. The explanation thereof will be omitted, however.

In the Tardos code structuring method, when the number of users is expressed as “n”, the number of colluders is expressed as “c”, the error probability is expressed as “e”, and the code length is expressed as “m”, the code length m can be expressed by using Expression 8 below.

100c²┌ln(n/ε)┐ (8)

At step S301, it will be appropriate if the code length specifying unit 502 specifies the code length m′ so as to be a value expressed by Expression 9.

100c²┌ln(t·n/ε)┐ (9)

The threshold value to be used in the judging process performed by the pirate user detecting apparatus 200 to judge whether each of the users is a pirate user is expressed by Expression 10.

20c┌ln(n/ε)┐ (10)

It will be appropriate if the collusion-secure code generating unit 503 generates a collusion-secure code at step S302 by assuming that a threshold value expressed by Expression 11 below is used instead by the pirate user detecting apparatus 200.

20c┌ln(t·n/ε)┐ (11)

By embedding the collusion-secure code that has been generated in the manner described above into a digital content, it is possible to keep the probability of making erroneous judgments equal to or lower than the presumed level (i.e., equal to or lower than “e”), even in the case where the pirate user detecting apparatus 200 performs, by using the collusion-secure code, the judging process of judging whether each of the users is a pirate user at most “t” times per user. Thus, it is possible to satisfy the specified safety conditions.

The reason why this is possible can be explained as below: When the number of users is expressed as “n”, while the probability of accusing an innocent user of being a pirate user in one judging process cycle is expressed as “eₜ”, the maximum possible number of innocent users is “n−1”, whereas the probability of the pirate user detecting apparatus 200's correctly judging all the innocent users in one judging process cycle is “(1−eₜ)ⁿ⁻¹”.

If it is assumed that each of the judging process cycles is independent of other judging process cycles, the probability of erroneously accusing an innocent user of being a pirate user in the second judging process cycle is also “eₜ” and unchanged. Thus, the probability of correctly judging all the innocent users in the second judging process cycle is also “(1−eₜ)ⁿ⁻¹”.

In actuality, however, each of the judging process cycles is not independent of other judging process cycles. Thus, the error probability should be naturally much lower than the error probability calculated on the assumption. It should be noted, however, that this evaluation is based on an estimated error probability on the standpoint that the error probability cannot be any higher than the error probability on which this evaluation is based.

Each judging process cycle is ended whenever at least one pirate user has been accused. Thus, a judging process cycle is ended also when an innocent user has erroneously been accused of being a pirate user. Consequently, in the second or later judging process cycle, the judging process is performed on the users that have correctly been judged to be innocent users in the first judging process cycle. Taking this into account, the probability of having none of the innocent users erroneously accused at the time when the second judging process cycle has been finished can be expressed as “(1−eₜ)²⁽ⁿ⁻¹⁾”. Because this judging process cycle is repeated “t” times, the probability of having none of the innocent users erroneously accused at the time when the t'th judging process cycle has been finished can be expressed as “(1−et)^{t(n-1)}”.

In this situation, in the case where it is assumed that “t(n−1)eₜ<<1” is satisfied, “(1−eₜ)^{t(n-1)}>1−t(n−1)eₜ” is satisfied. Accordingly, it is understood that the error probability of erroneously accusing innocent users of being pirate users is equal to or lower than t(n−1)eₜ.

The assumption that “t(n−1)eₜ<<1” is satisfied is made for the following reason: When “t(n−1)eₜ” is close to “1”, it is implied that the error probability itself is close to “1” or that “t” is an extremely large value. Thus, in view of the safety conditions and the notion that the estimated value of “t” is at most the number of colluders “c”, the assumption above is considered to be appropriate.

For example, in the Tardos code structuring method, the probability of erroneously accusing innocent users of being pirate users in one judging process cycle is assumed to be “(n−1)e/n”. By comparing this probability value with the probability of erroneously accusing innocent users by performing the judging process at most “t” times per user, “1−t(n−1)eₜ=(n−1)e/n” is satisfied. By rearranging this, “eₜ=e/(n·t)” is obtained. Originally in the structuring method of Tardos code, the probability of erroneously accusing an innocent user is expressed as “e/n”. Thus, by keeping the probability of erroneously accusing an innocent user equal to or lower than “1/t” times the originally presumed error probability, it is possible to keep the error probability, as a whole, equal to or lower than “e”. In this situation, “e” denotes the error probability value that is presumed in advance, as explained above. “e” denotes the error probability value that is specified in correspondence with the case where the number of times the judging process can be performed is only one per user.

The term “errors” in this situation can mean two things: one is “being unable to accuse any pirate users”, and the other is “accusing innocent users of being pirate users”. Of these two, the probability of “being unable to accuse any pirate users” will be equal to or lower than “e”, even after the judging process has been performed “t” times, as long as this probability value is maintained so as to be equal to or lower than “e” in one judging process cycle. On the other hand, as explained above, the probability of “accusing innocent users of being pirate users” will be multiplied by “t” in a worst-case scenario, after the judging process has been performed “t” times. It is understood that, to maintain the error probability, as a whole, so as to be equal to or lower than “e” after the t'th judging process cycle has been performed, the error probability of “accusing innocent users as pirate users” by performing the judging process only once at least should be the one that is multiplied by “1/t” or lower.

In the description of the exemplary embodiments above, the pirate user detecting apparatus is configured so as to include the code extracting unit; however, another arrangement is acceptable in which the pirate user detecting apparatus does not include the code extracting unit, but includes a communication controlling device that performs communication with a computer provided on the outside of the pirate user detecting apparatus via a network, so that the pirate user detecting apparatus obtains the code that is the target of the process by receiving the code extracted out of a content via the communication controlling device.

In any of the embodiments described above, an arrangement is acceptable in which the various types of programs executed by the pirate user detecting apparatus are stored in a computer connected to a network such as the Internet so that the programs are provided as being downloaded via the network. Another arrangement is acceptable in which the various types of programs are provided as being recorded on a computer-readable recording medium such as a Compact Disk Read-Only Memory (CD-ROM), a Flexible Disk (FD), a Compact Disk Recordable (CD-R), or a Digital Versatile Disk (DVD), in a file that is in an installable format or in an executable format.

It is acceptable to combine a part or all of the configurations according to the first embodiment with a part or all of the configurations according to the second embodiment. The combined configurations are useful, for example, in the case where it is not possible to obtain the entirety of a code, but it is possible to obtain a part of the code having a sufficient code length, or in the case where the operator of the apparatus wishes to trace pirate users in advance by using an extremely short code by giving priority to efficiency, even though only a part of a code has been extracted.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A pirate user detecting apparatus comprising:
an extracting unit that extracts, from a digital content, a part or all of a collusion-secure code that is embedded in correspondence with each of users and that makes it possible to trace pirate users who have made a collusion attack;
a calculating unit that calculates a correlation value for each of bits between the part or all of the extracted collusion-secure code and a code assigned to a corresponding one of the users, and calculates a total score of the correlation values for each of the users;
a first specifying unit that specifies a threshold value used for judging whether each of the users is a pirate user, based on a code length of the part or all of the extracted collusion-secure code; and
a judging unit that judges whether each of the users is a pirate user by using the specified threshold value and the calculated total score of each user.

2. The apparatus according to claim 1, wherein the first specifying unit calculates a number indicating how many pirate users are estimated in advance in correspondence with the code length, calculates the threshold value by using the number of pirate users, and specifies the threshold value.

3. The apparatus according to claim 1, further comprising:
an extending unit that extends the code length, when the judging unit has judged none of the users to be a pirate user; and
a second specifying unit that re-specifies the threshold value based on the extended code length, wherein the judging unit judges whether each of the users is a pirate user by using the re-specified threshold value and the calculated total score of each user.

4. The apparatus according to claim 3, wherein
a maximum number-of-times value is specified in advance, the maximum number-of-times value indicating how many times per user the judging unit is able to judge whether the user is a pirate user, and
the extending unit extends the code length, when a judging process number-of-times value indicating how many times the judging unit has judged each of the users has not exceeded the maximum number-of-times value, and also when the judging unit has judged none of the users to be a pirate user.

5. The apparatus according to claim 4, wherein
the pirate number of users is specified in advance in correspondence with the judging process number-of-times value in such a manner that the larger the judging process number-of-times value is, the larger the estimated number of pirate users is,
the extending unit extends the code length by re-calculating the code length by using the number of pirate users specified in advance in correspondence with the judging process number-of-times value, and
the calculating unit calculates the total score for each of the users by using the extracted collusion-secure code having the extended code length, and the code assigned to the corresponding one of the users.

6. A collusion-secure code generating apparatus that generates a collusion-secure code to be embedded into a digital content in correspondence with each of users so as to make it possible to trace pirate users who have made a collusion attack, the apparatus comprising:
a specifying unit that specifies a code length based on a number indicating how many pirate users are estimated, a number indicating how many users there are, and an error probability indicating a probability of erroneously judging any of the users as pirate users; and
a generating unit that generates the collusion-secure code having the specified code length, wherein
when a pirate user detecting apparatus operable to detect pirate users by using the collusion-secure code is able to perform a judging process of judging whether each of the users is a pirate user a plurality of times per user, the specifying unit specifies the code length according to a maximum number-of-times value t (t: an integer that is equal to or larger than 2) indicating a maximum number of times the pirate user detecting apparatus is able to perform the judging process.

7. The apparatus according to claim 6, wherein
the specifying unit includes
a probability specifying unit that, when the pirate user detecting apparatus operable to detect pirate users by using the collusion-secure code is able to perform the judging process of judging whether each of the users is a pirate user at most t times per user, re-specifies the error probability so that the error probability is equal to or lower than 1/t times an error probability compared to a case where the maximum number-of-times value is 1, and
a code length specifying unit that specifies the code length based on the re-specified error probability, the number of pirate users, and the number of users.

8. A computer program product having a computer readable medium including programmed instructions, wherein the instructions, when executed by a computer, cause the computer to perform:
extracting, from a digital content, a part or all of a collusion-secure code that is embedded in correspondence with each of users and that makes it possible to trace pirate users who have made a collusion attack;
calculating correlation value for each of bits between the part or all of the extracted collusion-secure code and a code assigned to a corresponding one of the users, and calculating a total score of the correlation values for each of the users;
specifying a threshold value used for judging whether each of the users is a pirate user, based on a code length of the part or all of the extracted collusion-secure code; and
judging whether each of the users is a pirate user by using the specified threshold value and the calculated total score of each user.

9. A computer program product having a computer readable medium including programmed instructions, when executed by a computer included in a collusion-secure code generating apparatus that generates a collusion-secure code to be embedded into a digital content in correspondence with each of users so as to make it possible to trace pirate users who have made a collusion attack, wherein the instructions cause the computer to perform:
specifying a code length based on a number indicating how many pirate users are estimated, a number indicating how many users there are, and an error probability indicating a probability of erroneously judging any of the users as pirate users; and
generating the collusion-secure code having the specified code length, wherein
when a pirate user detecting apparatus operable to detect pirate users by using the collusion-secure code is able to perform a judging process of judging whether each of the users is a pirate user a plurality of times per user, the code length is specified according to a maximum number-of-times value t (t: an integer that is equal to or larger than 2) indicating a maximum number of times the pirate user detecting apparatus is able to perform the judging process.
